(19) United States
(12) Patent Application Publication
(10) Pub. No.: US 2021/0026287 A1
(43) Pub. Date: Jan. 28, 2021

(54) POWER SUPPLY APPARATUS AND IMAGE FORMING APPARATUS

(71) Applicant: Konica Minolta, Inc., Tokyo (JP)

(72) Inventors: Makoto SHIMAZOE, Toyokawa-shi (JP); Yoshihito SASAMOTO, Tokyo (JP); Yasuhiro KOIDE, Toyohashi-shi (JP); Yuhei TATSUMOTO, Toyokawa-shi (JP)

(21) Appl. No.: 16/930,890

(22) Filed: Jul. 16, 2020

(30) Foreign Application Priority Data
Jul. 25, 2019 (JP) 2019-136757

(51) Int. Cl. G03G 15/00

(52) U.S. Cl. CPC G03G 15/80; G03G 2215/00978; G03G 15/5004

(57) ABSTRACT

A power supply apparatus includes a predetermined mode in which power consumption is suppressed and a normal mode in which the power consumption is not suppressed and which supplies power to an apparatus. the power supply apparatus includes the following, a cutting member which cuts off supply of the power to a fixing heater; a noise removing member which is positioned in a later stage of the cutting member and which removes noise in the power; and a controller which controls the cutting member. The controller controls the cutting member to cut off supply of the power to the noise removing member in the predetermined mode.

### CROSS-REFERENCE TO RELATED APPLICATIONS

The present invention claims priority under 35 U.S.C. § 119 to Japanese Application No. 2019-136757 filed on Jul. 25, 2019, the entire content of which is incorporated herein by reference.

### BACKGROUND

### Technological Field

The present invention relates to a power supply apparatus and an image forming apparatus including the power supply apparatus.

### Description of the Related Art

Since power consumption regulations such as Energy Star of the United States are becoming more stringent, the manufacturers of multifunction printers are competing to achieve lower typical electricity consumption values (TEC). The power consumption amount in a sleep state may influence the measurement of the TEC value. Recently, standards have changed so that the degree of influence increased. Therefore, there is a demand for enhancing efficiency of the sleep state. Although the amount is small, regarding the energy consumption in the sleep state, the current flowing in a noise removal X capacitor (across capacitor) used in a noise filter used in a switching power supply (AC to DC) provided in a multifunction printer may invite worse efficiency in the sleep state with influence from the loss (loss by Joule heat) due to heating in the resistance of a power supply cord (copper line). Since the consumption current in the sleep state is 0.5 W or less, it is about one-eight hundredth compared to 400 W which is the normal consumption current. In such situation, most of the noise is suppressed and there is no need for the X capacitor. Therefore, there may be attempts to improve the efficiency by cutting off the X capacitor using a cutting function such as a relay in the sleep state.

For example, JP 2014-192952 discloses a configuration in which a switch switches from an electrolytic capacitor with a high capacity and a large leak current to a film capacitor (ceramic capacitor) with a small capacity and a small leak current as a configuration to reduce power consumption in a low power consumption state.

JP 2014-153451 discloses a configuration in which a relay switches from a main power supply apparatus to an auxiliary power supply apparatus.

JP 2012-137910 discloses a configuration which separates an X capacitor with a relay.

However, the configuration shown in JP 2014-192952 is a configuration which switches a primary smoothing capacitor. This cannot be applied to cutting off the X capacitor as the noise removing member. The configuration described in JP 2014-153451 is a configuration which switches the power supply apparatus and cannot be applied to cutting off the X capacitor.

The configuration described in JP 2012-137910 is a configuration which separates the X capacitor with a relay and this can be applied to cutting off the X capacitor. However, a function to cut off the X capacitor is newly added and costs increase.

### SUMMARY

It is an object of the present invention to provide a power supply apparatus which is able to suppress efficiency becoming worse in a sleep state without increasing costs, and an image forming apparatus provided with such power supply apparatus.

To achieve at least one of the abovementioned objects, according to an aspect of the present invention, a power supply apparatus reflecting one aspect of the present invention includes a predetermined mode in which power consumption is suppressed and a normal mode in which the power consumption is not suppressed and which supplies power to an apparatus, the power supply apparatus including: a cutting member which cuts off supply of the power to a fixing heater; a noise removing member which is positioned in a later stage of the cutting member and which removes noise in the power; and a controller which controls the cutting member, wherein, the controller controls the cutting member to cut off supply of the power to the noise removing member in the predetermined mode.

According to another aspect of the present invention, an image forming apparatus includes, an image former which forms a toner image on a sheet, a power supply apparatus, wherein, the image former includes a fixing heater which heats the fixing member to fix on the sheet the toner image formed by the image former.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view showing a schematic configuration of the image forming apparatus according to the present embodiment,

FIG. 2 is a functional block diagram showing a control configuration of the image forming apparatus according to the present embodiment,

FIG. 3 is a circuit diagram showing a configuration of a power supply apparatus according to the present embodiment,

FIG. 4 is a circuit diagram showing a configuration of a power supply apparatus according to modification 1.

FIG. 5 is a circuit diagram showing a configuration of a power supply apparatus according to modification 2.

### DETAILED DESCRIPTION OF THE EMBODIMENTS

Hereinafter, one or more embodiments of the present invention will be described in detail with reference to the drawings. However, the scope of the invention is not limited to the disclosed embodiments and the illustrated drawings.

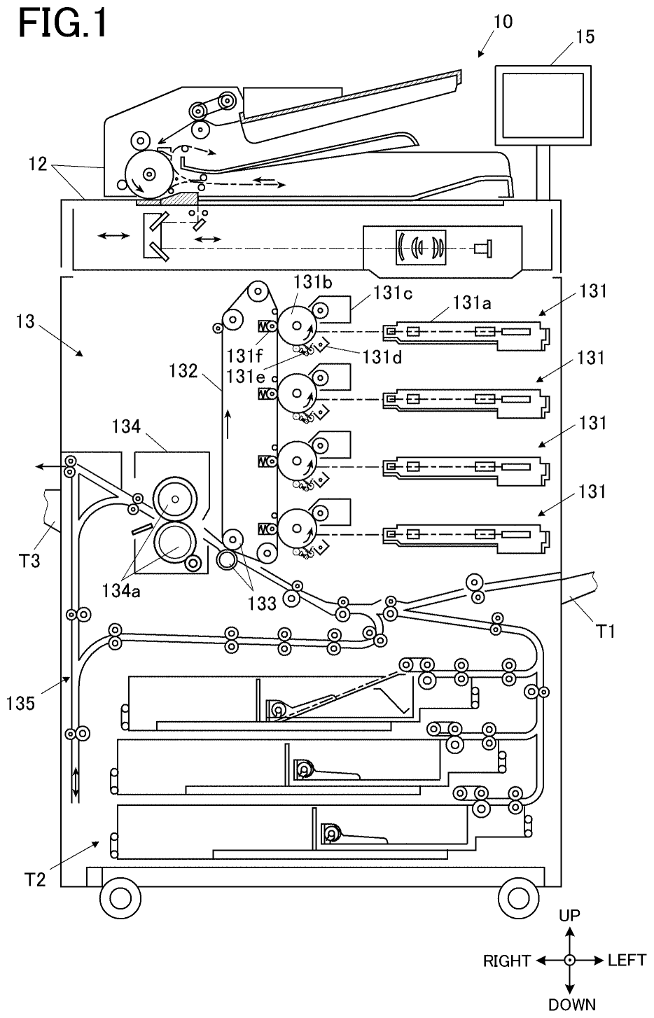

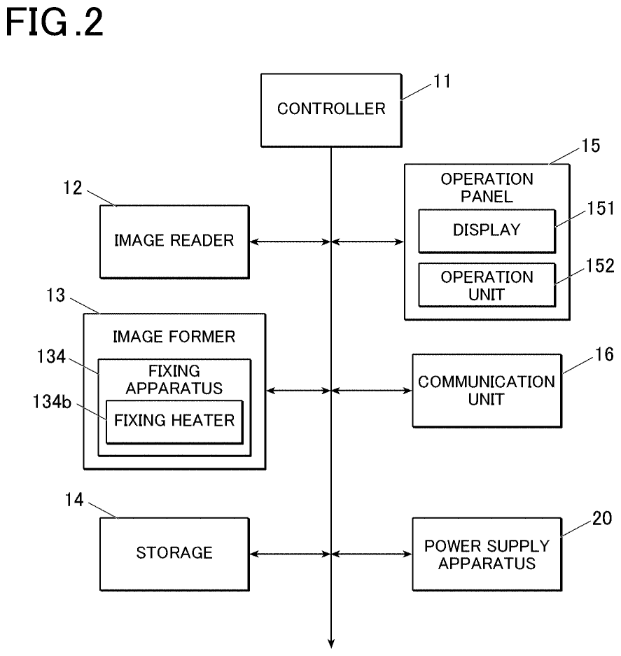

As shown in FIG. 1 and FIG. 2, the image forming apparatus 10 according to the present embodiment includes a controller 11, an image reader 12, an image former 13, a storage 14, an operation panel 15 (display 151, operation unit 152), a communication unit 16, and a power supply apparatus 20.

The controller 11 includes a CPU, a RAM, and a ROM. In response to an operation signal input from the operation unit 152 or an instruction signal received by the communication unit 16, the CPU retrieves various processing programs stored in the ROM and deploys the program in the RAM. In coordination with the various programs deployed in the RAM, the CPU collectively controls the operation in the image forming apparatus 10.

The image forming apparatus 10 includes a predetermined mode in which power consumption is suppressed, and a normal mode in which power consumption is not suppressed. The controller 11 is able to switch between the predetermined mode and the normal mode. The normal mode includes, for example, a print mode, or a standby mode. The predetermined mode includes, for example, sleep mode, ERP mode, or plug off mode.

The image reader 12 uses the optical system of the scanning exposure device to scan and expose the image of the document placed on a document stage or an automatic document feeder (ADF) which are not shown. The image reader 12 reads the reflected light with the line image sensor and with this, obtains an image signal. After processes such as A/D conversion, shading correction, and compression are performed on the image signal, the image signal is input in the controller 11 as image data. The image data input in the controller 11 is not limited to image data read using the image reader 12, and for example, the image data may be received from an external device (not shown) through the communication unit 16.

The image former 13 forms an image including the four colors C, M, Y and K on the sheet according to the pixel value of the four colors in each pixel of the original image on which the image processes are performed.

As shown in FIG. 1, the image former 13 includes four writing units 131, an intermediate transfer belt 132, a secondary transfer roller 133, and a fixing apparatus 134.

The four writing units 131 are positioned in a series (tandem) along a belt surface of the intermediate transfer belt 132, and form the images in colors including C, M, Y, and K. As shown in FIG. 2, the writing units 131 include a light scanning apparatus 131a, a photoconductor 131b, a developer 131c, a charger 131d, a cleaner 131e, and a primary transfer roller 131f The writing units 131 have the same configuration and the only difference is the color of the image to be formed.

When the image is formed, in each writing unit 131, after the photoconductor 131b is charged by the charger 131d, a luminous flux emitted by the light scanning apparatus 131a based on the original image scans the photoconductor 131b and forms an electrostatic latent image. The color material such as toner is supplied and the image is developed by the developer 131c. Then, the image is formed on the photoconductor 131b.

Each image formed on the photoconductor 131b for each of the four writing units 131 is transferred by each primary transfer roller 131f and overlapped sequentially on the intermediate transfer belt 132 (primary transfer). With this, the image including each color is formed on the intermediate transfer belt 132. The intermediate transfer belt 132 is an image carrier which rotates by being turned by a plurality of rollers. After the primary transfer, the color material remaining on the photoconductor 131b is removed by the cleaner 131e.

In the image former 13, a sheet is fed from a manual feed tray T1 or a sheet feed tray T2 to match the timing that the image on the rotating intermediate transfer belt 132 reaches the position of the secondary transfer roller 133. One of the pair of the secondary transfer rollers 133 presses with contact on the intermediate transfer belt 132 and the other roller is included as one of the plurality of rollers which rotate the intermediate transfer belt 132. When the image is transferred (secondary transfer) on the sheet from the intermediate transfer belt 132 due to the pressure of the secondary transfer roller 133, the fixing apparatus 134 conveys the sheet and performs the fixing process, and the sheet is ejected to a sheet eject tray T3. The fixing apparatus 134 includes a pair of fixing rollers (fixing member) 134a and a fixing heater 134b (see FIG. 2) which heats one or both of the fixing rollers 134a. For example, the fixing heater 134b is an IH heater. The fixing heater 134b may be a halogen heater or a ceramic heater. The fixing process is a process which fixes the image (toner image) on a sheet through pressure by the pair of fixing rollers 134a and the heat included in the fixing roller 134a. When the image is formed on both sides of the sheet, after the sheet is conveyed on an inverting path 135 and the sheet surface is reversed, the sheet is fed to the position of the secondary roller 133 again.

The storage 14 is a nonvolatile storage including a HDD (Hard Disk Drive), a SSD (solid state drive) or the like, and various programs and various setting data are stored so that the controller 11 is able to retrieve and rewrite the above.

The operation panel 15 includes a display 151 which displays various information to the user and an operation unit 152 which receives input of operation by the user.

The display 151 includes a color liquid crystal display and displays an operation screen, etc. (various setting screens, various buttons, operation state of various functions) according to a display control signal input from the controller 11.

The operation unit 152 includes a touch panel provided on a screen of the display 151 and various hardware keys positioned around the screen of the display 151. When a button displayed on the screen is pressed by a finger or a touch pen, the operation unit 152 detects XY coordinates of the pressed pressure point as a voltage value, and the operation signal corresponding to the detected position is output to the controller 11. The touch panel is not limited to a pressure sensitive type and can be an electrostatic type or an optical type. When the hardware key is pressed the operation unit 152 outputs the operation signal corresponding to the pressed key to the controller 11. The user operates the operation unit 152 and is able to perform setting regarding the image forming such as image quality setting, magnification setting, advanced setting, output setting, and sheet setting. The user is also able to instruct sheet conveying or is able to stop the operation.

The communication unit 16 is an interface which connects the image forming apparatus 10 to a communication network N. The communication unit 16 includes a communication IC and a communication connector. Under the control of the controller 11, the communication unit 16 communicates various information with the external apparatus connected to the communication network N using the predetermined communication protocol. The communication unit 16 is able to input and output various information through a USB.

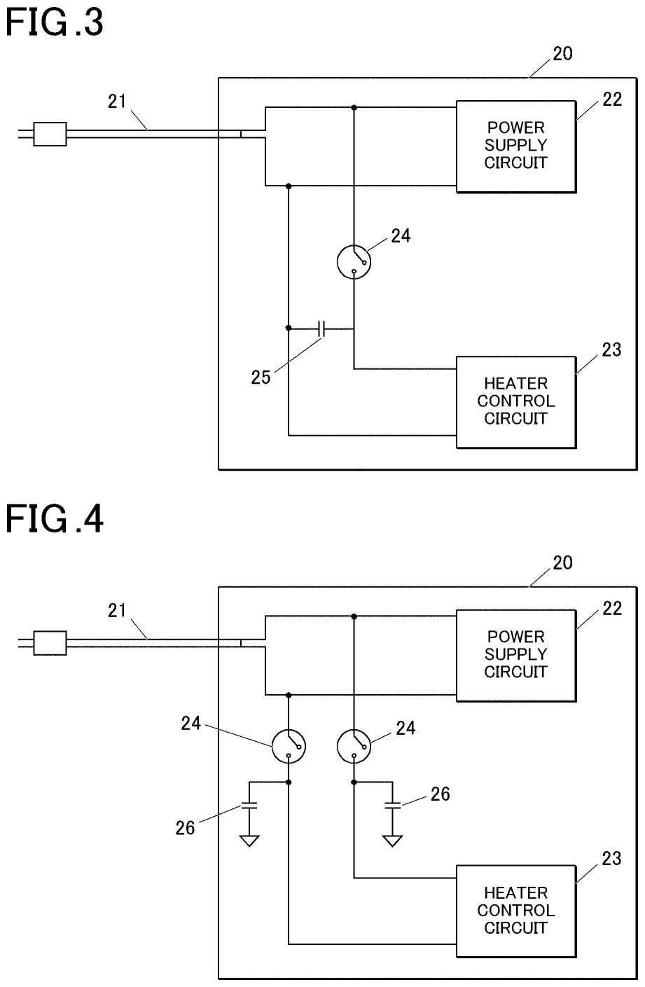

As shown in FIG. 3, the power supply apparatus 20 includes a power supply cord 21 which supplies power to various circuits from a commercial power supply, a power supply circuit 22 which supplies power supplied from the power supply cord 21 to the units included in the image forming apparatus 10, a heater control circuit 23 which supplies power supplied by the power supply cord 21 to a fixing heater 134b, a relay 24 (cutting member) which cuts supply of power to the fixing heater 134b (heater control circuit 23), and a X capacitor 25 (noise removing member) which removes noise in the power.

The power supply apparatus according to the present embodiment includes at least the power supply apparatus 20 and the controller 11 which controls the relay 24.

The X capacitor 25 is provided in a later stage of the relay 24. With this, when the relay 24 cuts off supply of power to the fixing heater 134b (heater control circuit 23), the supply of power to the X capacitor 25 is also cut off. In a normal sleep mode, the fixing heater 134b is stopped, and the relay 24 cuts off the supply of power to the fixing heater 134b. Therefore, according to the present embodiment, the supply of power to the X capacitor 25 is cut off in the normal sleep mode.

According to the present embodiment, in a predetermined mode (for example, sleep mode, etc.) the controller 11 controls the relay 24 to cut off supply of power to the X capacitor 25.

As described above, the power supply apparatus (power supply apparatus 20, controller 11) of the image forming apparatus 10 according to the present embodiment includes, the cutting member (relay 24) which cuts off supply of power to the fixing heater 134b, the noise removing member (X capacitor 25) which is provided in a later stage of the cutting member and which removes noise in the power, and a controller 11 which controls the cutting member. The controller 11 controls the cutting member to cut off supply of power to the noise removing member in a predetermined mode.

Therefore, according to the power supply apparatus of the present embodiment, in a situation in which the noise is drastically low in a low load mode such as the sleep mode, the conducting to the noise removing member can be blocked, and the generating of loss due to Joule heat can be suppressed. Therefore, it is possible to enhance efficiency. The effect that the efficiency is enhanced changes with the capacity of the noise removing member and the thinness and the length of the power supply cord 21. For example, if the resistance of the power supply cord 21 is 500 mΩ, and the capacity of the noise removing member is 1 uF, the efficiency can be enhanced by 1.5%. There is no need to newly add a function to cut the power supply to the noise removing member, and the cutting member used to cut off the power supply to the fixing heater 134b can be used. Therefore, it is possible to suppress increase in cost. Therefore, the efficiency worsening in the sleep mode can be suppressed without increasing costs.

The power supply according to the present embodiment includes the X capacitor 25 as the noise removing member.

Therefore, according to the power supply apparatus of the present embodiment, the conducting to the X capacitor 25 can be blocked in the low load mode. Therefore, it is possible to suppress loss due to Joule heat. With this, the efficiency can be enhanced.

According to the power supply apparatus of the present embodiment, the fixing heater 134b is an IH heater.

Therefore, according to the power supply apparatus of the present embodiment, there is no need to newly add the function to cut off the power supply to the noise removing member and the cutting member used to cut off the power supply to the IH heater can be used. With this, the increase in costs can be suppressed.

The embodiments of the present invention are described in detail, but the present invention is not limited to the embodiments described above, and various modifications are possible without leaving the scope of the present invention.

(Modification 1)

For example, according to the above embodiment, the X capacitor 25 is described as the noise removing member, but the present invention is not limited to the above. For example, as shown in FIG. 4, as the noise removing member, instead of the X capacitor 25, a Y capacitor 26 can be used. The example shown in FIG. 4 describes a configuration in which two sets of the combination including the relay 24 and the Y capacitor 26 are provided. The Y capacitor 26 is provided in a later stage of the relay 24, and the noise in the power is removed. Similar to the X capacitor 25 in the above-described embodiment, when the relay 24 cuts off the supply of power to the fixing heater 134b (heater control circuit 23), the supply of power to the Y capacitor 26 is also cut off at the same time.

According to modification 1, the controller 11 controls the relay 24 to cut off the supply of power to the Y capacitor 26 in the predetermined mode (for example, sleep mode).

As described above, according to the power supply apparatus in modification 1, the noise removing member is the Y capacitor 26.

Therefore, according to the power supply apparatus in modification 1, in the low load mode, the conducting to the Y capacitor 26 can be cut. Therefore, it is possible to suppress loss due to Joule heat. With this, the efficiency is enhanced.

(Modification 2)

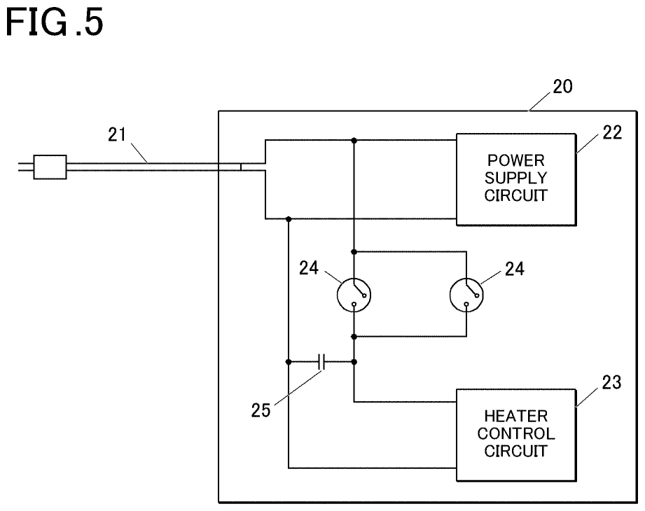

According to the above-described embodiment, a configuration providing one relay 24 as the cutting member is described, but the present invention is not limited to the above. For example, as shown in FIG. 5, a plurality of relays 24 (FIG. 5 shows two) can be provided in parallel. A plurality of relays 24 are provided in parallel at a prior stage of the X capacitor 25, and the relays 24 cut off the supply of power to the fixing heater 134b (heater control circuit 23). When the plurality of relays 24 provided in parallel cut off the supply of power to the fixing heater 134b (heater control circuit 23), the supply of power to the X capacitor 25 is also cut off at the same time.

According to the modification 2, the controller 11 controls the plurality of relays 24 provided in parallel to cut off the supply of power to the X capacitor in the predetermined mode (for example, sleep mode, etc.).

As described above, according to the power supply apparatus of modification 2, a plurality of cutting members are provided in parallel.

Therefore, according to the power supply apparatus of modification 2, the impedance can be decreased and the noise can be attenuated. With this, the noise removal becomes more efficient.

According to the present embodiment, the relay 24 is described as the cutting member, but the present invention is not limited to the above. For example, instead of the relay 24, a switch can be used as the cutting member.

The detailed configuration and the detailed operation of the apparatuses included in the image forming apparatus can be changed without leaving the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A power supply apparatus which includes a predetermined mode in which power consumption is suppressed and a normal mode in which the power consumption is not suppressed and which supplies power to an apparatus, the power supply apparatus comprising:
a cutting member which cuts off supply of the power to a fixing heater;
a noise removing member which is positioned in a later stage of the cutting member and which removes noise in the power; and
a controller which controls the cutting member,
wherein, the controller controls the cutting member to cut off supply of the power to the noise removing member in the predetermined mode.

2. The power supply apparatus according to claim 1, wherein the noise removing member is an X capacitor.

3. The power supply apparatus according to claim 1, wherein the noise removing member is a Y capacitor.

4. The power supply apparatus according to claim 1, wherein the fixing heater is an IH heater.

5. The power supply apparatus according to claim 1, wherein a plurality of cutting members are provided in parallel.

6. An image forming apparatus comprising,
an image former which forms a toner image on a sheet,
a power supply apparatus according to claim 1,
wherein, the image former includes a fixing heater which heats the fixing member to fix on the sheet the toner image formed by the image former.
